(19) United States
(12) Patent Application Publication
(10) Pub. No.: US 2007/0261879 A1
(43) Pub. Date: Nov. 15, 2007

(54) Heavily Filled Halogen-Free Flame-Resistant Wrapping Foil

(75) Inventor: Bernhard Mussig, Seevetal (DE)

Correspondence Address: NORRIS, MCLAUGHLIN & MARCUS, PA, 875 THIRD AVENUE, 18TH FLOOR, NEW YORK, NY, 10022, US

(73) Assignee: Tesa AG, Hamburg (DE)

(21) Appl. No.: 10/574,028

(22) PCT Filed: Sep. 16, 2004
(86) PCT No.: PCT/EP04/52213

§ 371 Date: Apr. 20, 2007

(30) Foreign Application Priority Data
Oct. 14, 2003 (DE) 103 48 484.1

(51) Int. Cl. H01B 7/00

(52) U.S. Cl. 174/121 A

(57) ABSTRACT

A halogen-free, flame-resistant wrapping foil, characterized in that the wrapping foil is composed of polyolefin and contains more than 120 phr of metal hydroxide, preferably aluminum hydroxide and more preferably magnesium hydroxide.

The present invention relates to a heavily filled halogen-free flame-resistant wrapping foil, made of metal hydroxide and polyolefin, in particular polypropylene copolymer, which has been optionally provided with a pressure-sensitive adhesive coating and which is used, for example, for wrapping ventilation lines in air-conditioning units, wires or cables, and which is suitable in particular for cable harnesses in vehicles or field coils for picture tubes. This wrapping foil serves for bundling, insulating, marking, sealing or protecting. The invention further embraces processes for producing the foil of the invention.

Cable winding tapes and insulating tapes are normally composed of plasticized PVC film with a coating of pressure-sensitive adhesive on one side. There is an increased desire to eliminate disadvantages of these products. Such disadvantages include plasticizer evaporation and high halogen content.

The plasticizers in conventional insulating tapes and cable winding tapes gradually evaporate, leading to a health hazard; the commonly used DOP, in particular, is objectionable. Moreover, the vapors deposit on the glass in motor vehicles, impairing visibility (and hence, to a considerable extent, driving safety), this being known to the skilled worker as fogging (DIN 75201). In the event of even greater vaporization as a result of higher temperatures, in the engine compartment of vehicles, for example, or in electrical equipment in the case of insulating tapes, the wrapping foil is embrittled by the accompanying loss of plasticizer.

Plasticizers impair the fire performance of unadditized PVC, something which is compensated in part by adding antimony compounds, which are highly objectionable from the standpoint of toxicity, or by using chlorine- or phosphorus-containing plasticizers.

Against the background of the debate concerning the incineration of plastic wastes, such as shredder waste from vehicle recycling, for example, there exists a trend toward reducing the halogen content and hence the formation of dioxins. In the case of cable insulation, therefore, the wall thicknesses are being reduced, and the thicknesses of the PVC film are being reduced in the case of the tapes used for wrapping. The standard thickness of the PVC films for winding tapes is 85 to 200 μm. Below 85 μm, considerable problems arise in the calendering operation, with the consequence that virtually no such products with reduced PVC content are available.

The customary winding tapes comprise stabilizers based on toxic heavy metals, usually lead, more rarely cadmium or barium.

State of the art for the bandaging of sets of leads are wrapping foils with and without an adhesive coating, said foils being composed of a PVC carrier material which has been made flexible through incorporation of considerable amounts (30 to 40% by weight) of plasticizer. The carrier material is coated usually on one side with a self-adhesive mass based on SBR rubber. Considerable deficiencies of these adhesive PVC winding tapes are their low aging stability, the migration and evaporation of plasticizer, their high halogen content, and a high smoke gas density in the event of fire. JP 10 001 583 A1, JP 05 250 947 A1, JP 2000 198 895 A1 and JP 2000 200 515 A1 describe typical plasticized PVC adhesive tapes. In order to obtain higher flame retardancy in the platicized PVC materials it is usual, as described for example in JP 10 001 583 A1, to use the highly toxic compound antimony oxide.

There are attempts to use wovens or nonwovens instead of plasticized PVC film; however, the products resulting from such attempts are but little used in practice, since they are relatively expensive and differ sharply from the habitual products in terms of handling (for example, hand tearability, elastic resilience) and under service conditions (for example, resistance to service fluids, electrical properties), with—as set out below—particular importance being attributed to the thickness. Webs with this kind of thickness make the cable harnesses even thicker and more inflexible than conventional PVC tapes, albeit with a positive effect on soundproofing, which is of advantage only in certain areas of cable harnesses. Webs, however, lack stretchability and exhibit virtually no resilience. This is of importance on account of the fact that thin branches of cable harnesses must be wound with sufficient tautness that, when installed, they do not hang down loosely, and such that they can easily be positioned before the plugs are clipped on and attached. A further disadvantage of textile adhesive tapes is the low breakdown voltage of about 1 kV, since only the adhesive layer is insulating. Film-based tapes, in contrast, are situated at more than 5 kV; they have good voltage resistance. The following patent specifications may be mentioned as examples of textile adhesive tapes.

DE 200 22 272 U1, EP 1 123 958 A1 and WO 99/61541 A1 describe adhesive winding tapes comprising a clothlike (woven) or weblike (nonwoven) carrier material. These materials are distinguished by a very high tensile strength. A consequence of this, however, is the disadvantage that, when being processed, these adhesive tapes cannot be torn off by hand without the assistance of scissors or knives.

Stretchability and flexibility are two of the major requirements imposed on adhesive winding tapes, in order to allow the production of crease-free, flexible cable harnesses. Moreover, these materials do not meet the relevant fire protection standards such as FMVSS 302. Improved fire properties can be realized only with the use of halogenated flame retardants or polymers as described in US 4,992,331 A1.

DE 199 10 730 A1 describes a laminate backing composed of velour or foam material and a nonwoven, which is adhesively bonded by means of a double-sided adhesive tape or using a hotmelt adhesive.

Wrapping foils and cable insulation comprising thermoplastic polyester are being used on a trial basis for producing cable harnesses. They have considerable deficiencies in terms of their flexibility, processing qualities, aging stability or compatibility with the cable materials. The gravest disadvantage of polyester, however, is its considerable sensitivity to hydrolysis, which rules out use in automobiles on safety grounds.

DE 100 02 180 A1, JP 10 149 725 A1, JP 09 208 906 A1 and JP 05 017 727 A1 describe the use of halogen-free thermoplastic polyester carrier films. JP 07 150 126 A1 describes a flame-retardant wrapping foil comprising a polyester carrier film which comprises a brominated flame retardant.

Also described in the patent literature are winding tapes comprising polyolefins. These, however, are readily flammable or comprise halogenated flame retardants. Furthermore, the materials prepared from ethylene copolymers have too low a softening point (in general they melt even during an attempt to test them for stability to thermal aging), and in the case of the use of customary polypropylene polymers the material is too inflexible. Although metal hydroxides are sometimes used, the amounts employed, from 40 to 100 phr, are too low for adequate flame retardancy.

WO 00/71634 A1 describes an adhesive winding tape whose film is composed of an ethylene copolymer base material. The carrier film comprises the halogenated flame retardant decabromodiphenyl oxide. The film softens below a temperature of 95° C., but the normal service temperature is often above 100° C. or even briefly above 130° C., which is not unusual in the case of use in the engine compartment.

WO 97/05206 A1 describes a halogen-free adhesive winding tape whose carrier film is composed of a polymer blend of low-density polyethylene with an ethylene/vinyl acetate or ethylene/acrylate copolymer. The flame retardant used is 40 to 90 phr of aluminum hydroxide or ammonium polyphosphate. A considerable disadvantage of the carrier film is, again, the low softening temperature. To counter this the use of silane crosslinking is described. This crosslinking method, however, leads only to material with very nonuniform crosslinking, so that in practice it is not possible to realize a stable production operation or uniform product quality.

Similar problems of deficient heat distortion resistance occur with the electrical adhesive tapes described in WO 99/35202 A1 and U.S. Pat. No. 5,498,476 A1. The carrier film material described is a blend of EPDM and EVA in combination with ethylenediamine phosphate as flame retardant. Like ammonium polyphosphate, this flame retardant is highly sensitive to hydrolysis. In combination with EVA, moreover, there is an embrittlement on aging. Application to standard cables of polyolefin and aluminum hydroxide or magnesium hydroxide results in poor compatibility. Furthermore, the fire performance of such cable harnesses is poor, since these metal hydroxides act antagonistically with phosphorus compounds, as set out below. The insulating tapes described are too thick and too rigid for cable hardness winding tapes. The aforementioned patents operate without metal hydroxides, although an addition of up to 10 phr has been said to be possible.

Attempts to resolve the dilemma between excessively low softening temperature and flexibility and freedom from halogen are described by the patents below.

EP 0 953 599 A1 claims a polymer blend of LLDPE and EVA for applications as cable insulation and as film material. The flame retardant described comprises a combination of magnesium hydroxide of specific surface area and red phosphorus; however, softening at a relatively low temperature is accepted. The amount of magnesium hydroxide is 63 phr.

A very similar combination is described in EP 1 097 976 A1. In this case, though, for the purpose of improving the heat distortion resistance, the LLDPE is replaced by a PP polymer, which has a higher softening temperature. A disadvantage, however, is the resultant low flexibility. For blending with EVA or EEA it is maintained that the film has sufficient flexibility. From the literature, however, the skilled worker is aware that these polymers are blended with polypropylene in order to improve flame retardancy. The products described have a film thickness of 0.2 mm: this thickness alone rules out flexibility in the case of filled polyolefin films, since flexibility is dependent on the thickness to the 3rd power. With the extremely low melt indices of the polypropylenes used, as the skilled worker is aware, the described process of extrusion is virtually impossible to carry out on a production installation, and certainly not for a thin film in conformity to the art. The extremely low melt index limits use to 50 to 100 phr of magnesium hydroxide.

Both attempted solutions build on the known synergistic flame retardancy effect of red phosphorus with magnesium hydroxide. The use of elemental phosphorus, however, harbors considerable disadvantages and risks. In the course of processing, foul-smelling and highly toxic phosphine is released. A further disadvantage arises from the development of very dense white smoke in the event of fire. Moreover, only brown to black products can be produced, whereas for color marking wrapping foils are used in a broad color range.

JP 2001 049 208 A1 describes an oil- and heat-resistant sheet for an adhesive tape, in which both layers are composed of a mixture of EVA or EEA, peroxide crosslinker, silane crosslinker, silanol condensation catalyst and flame retardant and one of the layers additionally contains polypropylene. This sheet solves the problem neither of the poor flexibility of a filled polypropylene sheet nor of the exacting requirements in terms of aging resistance. The amount of magnesium hydroxide is 100 phr; polypropylene is not contained.

WO 03/070848 A1 describes a sheet made up of reactive polypropylene and 40 phr of magnesium hydroxide. This added amount is not enough for a substantial improvement in fire performance.

DE 203 06 801 U describes a polyurethane winding tape: such a product is much too expensive for the usual applications described above. There are no references to the use of aging inhibitors or magnesium hydroxide.

The stated patents of the prior art, in spite of the stated disadvantages, in particular lack of flame retardancy and/or heat resistance, do not indicate films or foils which also meet the further requirements such as hand tearability, compatibility with polyolefin cable insulation, or adequate unwind force. Furthermore, the possibility of processing in film production operations, high fogging number, and the breakdown voltage resistance remain questionable.

The object therefore remains that of finding a solution for a wrapping foil which combines the advantages of flame retardancy and heat resistance, abrasion resistance and voltage resistance with the mechanical properties (such as elasticity, flexibility, and hand tearability) of PVC winding tapes with the absence of halogen of textile winding tapes and, additionally, exhibits superior thermal aging resistance; at the same time, the possibility of industrial production of the foil must be ensured, and in certain applications high breakdown voltage resistance and high fogging number are necessary.

It is a further object of the invention to provide halogen-free flame-resistant wrapping foils which allow particularly rapid and reliable wrapping, particularly of wires and cables, for the purpose of marking, protecting, insulating, sealing or bundling, where the disadvantages of the prior art do not occur, of at least not to the same extent.

In concert with the evermore complex electronics and the increasing number of electrical consumer units in automobiles, the sets of leads as well are becoming increasingly more complex. With increasing cable harness cross sections the inductive heating is becoming ever greater, while the dissipation of heat is reducing. As a result there are increases in the thermal stability requirements of the materials used. The PVC materials used as standard for adhesive winding tapes are reaching their limits here. A further object was therefore to find polypropylene copolymers with additive combinations which not only match but indeed exceed the thermal stability of PVC.

This object is achieved by means of a wrapping foil as specified in the main claim. The dependent claims relate to advantageous developments of the wrapping foil of the invention, to its use in a carbon black-filled, aging-resistant, soft adhesive tape, to further applications thereof, and to processes for producing the wrapping foil.

The amounts below in phr denote parts by weight of the component in question per 100 parts by weight of all polymer components of the foil. For a coated wrapping foil (with adhesive, for example) only the parts by weight of all polymer components of the polyolefin-containing layer are regarded.

The invention accordingly provides a halogen-free, flame-retardant polyolefin wrapping foil, comprising more than 120 phr of metal hydroxide, preferably aluminum hydroxide and more preferably magnesium hydroxide.

The thickness of the foil of the invention is in the range from 30 to 180 μm, preferably 50 to 150 μm, in particular 55 to 100 μm. The surface may be textured or smooth. Preferably the surface is made slightly matt. This can be achieved through the use of a filler having a sufficiently high particle size or by means of a roller (for example, embossing roller on the calender or matted chill roll or embossing roller in the case of extrusion).

In a preferred version the foil is provided on one or both sides with a pressure-sensitively adhesive layer, in order to simplify application, so that there is no need to fasten the wrapping foil at the end of the winding operation.

The wrapping foil of the invention is substantially free from volatile plasticizers such as DOP or TOTM, for example, and therefore has excellent fire performance and low emissions (plasticizer evaporation, fogging).

Unforeseeably and surprisingly for the skilled worker such a wrapping foil made of polyolefin and metal hydroxide can be produced. Remarkably, in addition, the thermal aging stability, in comparison to PVC as a high-performance material, is not poorer but instead is comparable or even better.

The wrapping foil of the invention has in machine direction a force at 1% elongation of 0.6 to 5 N/cm, preferably of 1 to 3 N/cm, and at 100% elongation a force of 2 to 20 N/cm, preferably of 3 to 10 N/cm.

In particular the force at 1% elongation is greater than or equal to 1 N/cm and the force at 100% elongation is less than or equal to 15 N/cm.

The 1% force is a measure of the rigidity of the foil, and the 100% force is a measure of the conformability when it is wound with sharp deformation as a result of high winding tension. The 100% force must also not be too low, since otherwise the tensile strength is inadequate.

In order to achieve these force values the wrapping foil preferably comprises at least one polyolefin, in particular a polypropylene, having a flexural modulus of less than 900 MPa, preferably 500 MPa or less, and in particular 80 MPa or less.

With further preference the polyolefin is a polypropylene copolymer which is from a process in which a PP homopolymer or random PP copolymer is reacted further with ethylene and propylene.

The preferred melt index for calender processing is below 5 g/10 min, preferably below 1 g/10 min, and in particular below 0.7 g/10 min. For extrusion processing the preferred melt index is between 1 and 20 g/10 min, in particular between 5 and 15 g/10 min.

The crystallite melting point of the polyolefin is between 120° C. and 166° C., preferably below 148° C., more preferably below 145° C. The polyolefin may, for example, be a soft ethylene homopolymer or ethylene or propylene copolymer. With a softening point up to 145° C. it is found that aluminum hydroxide can also be combined with polypropylene; in the case of extrusion the skilled worker was aware that aluminum hydroxide, on extrusion with the standard polypropylenes, undergoes decomposition with elimination of water.

The crystalline region of the copolymer is preferably a polypropylene having a random structure, in particular with an ethylene content of 6 to 10 mol %. A polypropylene random copolymer modified (with ethylene, for example) has a crystallite melting point, depending on the block length of the polypropylene and the comonomer content of the amorphous phase, of between 120° C. and 145° C. (this is the range for commercial products).

Depending on molecular weight and tacticity, a polypropylene homopolymer is situated at between 163° C. to 166° C. If the homopolymer has a low molecular weight and has been modified with EP rubber (for example grafting, reactor blend), then the reduction in melting point leads to a crystallite melting point in the range from about 148° C. to 163° C. For the polypropylene copolymer of the invention, therefore, the preferred crystallite melting point is below 145° C. and is best achieved with a comonomer-modified polypropylene having random structure in the crystalline phase and copolymeric amorphous phase.

In such copolymers, there is a relationship between the comonomer content of both the crystalline phase and the amorphous phase, the flexural modulus, and the 1% tension value of the wrapping foil produced therefrom. A high comonomer content in the amorphous phase allows a particularly low 1% force value. Surprisingly, the presence of comonomer in the hard crystalline phase as well has a positive effect on the flexibility of the filled foil.

Attempts to date to achieve high flame retardancy without halogen have been based on the use of oxygen-containing ethylene copolymers such as EVA or ethylene acrylate, having a relatively high LOI as compared with standard polyolefins, in combination with small amounts of flame retardant. The result, governed by the base polymer, is low product softening points and low tensile strengths. The invention, however, is based on polyolefins with a relatively poor LOI in combination with very high amounts of flame retardant. The processing problems feared by the skilled worker can be solved. The resultant wrapping foils overcome the problem of hand tearability in polyolefin films, by virtue of the high filler content, and have high tensile strengths and superior flame retardancy. The latter can be increased still further by using high amounts of carbon black. When the preferred propylene copolymers are used the problem of low softening point is solved as well. In the specific embodiment with random polypropylene copolymer it is found that this polymer has an extraordinary capacity for fillers and is therefore especially suitable for the extremely large amounts of metal hydroxide.

The crystallite melting point should not, however, be below 120° C., as is the case with EPM and EPDM, since in the case of applications to ventilation pipes, picture coils or vehicle cables there is a risk of melting. Wrapping foils comprising ethylene-propylene copolymers from the classes of EPM and EPDM polymers are therefore not in accordance with the invention, although this does not rule out using such polymers to fine-tune the mechanical properties, in addition to the polypropylene copolymer of the invention.

There are no restrictions imposed on the monomer or monomers in the polyolefin, although preference is given to using α-olefins such as ethylene, propylene, 1-butylene, isobutylene, 4-methyl-1-pentene, hexene or octene. Copolymers having three or more comonomers are included for the purposes of this invention. Particularly preferred monomers for the polypropylene copolymer are propylene and ethylene. The polymer may additionally be modified by grafting, with maleic anhydride or acrylate monomers, for example, for the purpose, for example, of enhancing the processing characteristics or the mechanical properties. By polypropylene copolymer is meant not only copolymers in the strict sense of polymer physics, such as block copolymers, for example, but also commercially customary thermoplastic PP elastomers with a wide variety of structures or properties. Materials of this kind may be prepared, for example, from PP homopolymers or random copolymers as a precursor by further reaction with ethylene and propylene in the gas phase in the same reactor or in subsequent reactors. When random copolymer starting material is used the monomer distribution of ethylene and propylene in the EP rubber phase which forms is more uniform, leading to improved mechanical properties. This is another reason why a polymer with a crystalline random copolymer phase is preferred for the wrapping foil of the invention. For the preparation it is possible to employ conventional processes, examples including the gas-phase process, Cataloy process, Spheripol process, Novolen process, and Hypol process, which are described in Ullmann's Encyclopedia of Industrial Chemistry, 6th ed., Wiley-VCH 2002.

Soft, olefin-based blend components can also be present in not too great an amount (below 50 phr). They are, for example, soft ethylene copolymers such as LDPE, LLDPE, metallocene-PE, EPM or EPDM with a density of 0.86 to 0.92 g/cm³, preferably from 0.86 to 0.88 g/cm³. Soft hydrogenated random or block copolymers of ethylene or (unsubstituted or substituted) styrene and butadiene or isoprene are also suitable for bringing the flexibility, the force at 1% elongation, and, in particular, the shape of the force/elongation curve of the wrapping foil into the optimum range. If in addition to the polypropylene copolymer of the invention a further ethylene or propylene copolymer is used it preferably has a specified melt index in the range of ±50% of the melt index of the polypropylene copolymer. This is without taking into account the fact that the melt index of ethylene copolymers is generally specified for 190° C. and not, as in the case of polypropylene, for 230° C.

By using ethylene copolymers with carbonyl-containing monomers such as ethylene acrylate (for example EMA, EBA, EEA, EAA) or ethylene-vinyl acetate it is possible, as the skilled worker is aware, to improve the fire performance of PP polymers. This is also the case for the wrapping foil of the invention, having a polymer with the properties specifically required here. Furthermore, it is found and claimed that polyethylene-vinyl alcohol and olefin-free, nitrogen- or oxygen-containing polymers are also suitable as synergists, in the form for example of polyvinyl alcohol; polyamides and polyesters having a sufficiently low softening point (fitting in with the processing temperature of polypropylene), polyvinyl acetate, polyvinyl butyral, vinyl acetate-vinyl alcohol copolymer, and poly(meth)acrylates. These highly polar materials are considered by the skilled worker not to be compatible with polypropylene, since the solubility parameter is at least 19 J^{1/2}/cm^{3/2}. Surprisingly this proves not to be a problem in the case of the inventive blending of specific copolymer and flame-retardant filler. Preference is given to polyvinyl acetate and poly(meth)acrylates, which may also have been crosslinked. They may also have a core-shell structure: for example, a core of polyacrylates of alcohols having 2 to 8 carbon atoms and a shell of polymethyl methacrylate. In particular, acrylate impact modifiers, which are prepared for modifying PVC, prove particularly suitable, since even in small amounts they produce a substantial improvement in fire performance, while not substantially impairing the flexibility of the wrapping foil and, in spite of their polarity, not increasing the sticking of the melt to calender rolls or chill rolls.

A further possibility lies in the use of polyolefins in which the oxygen is introduced by grafting (for example, with maleic anhydride or a (meth)acrylate monomer). In one preferred embodiment the fraction of oxygen, based on the total weight of all polymers, is between 0.5 and 5 phr (also corresponding to % by weight), especially 0.8 to 3 phr. If in addition to the polypropylene copolymer of the invention a thermoplastic oxygen- or nitrogen-containing polymer is employed, it preferably has a specified melt index in the range of ±50% of the melt index of the polypropylene copolymer. One specific embodiment is a wrapping foil having at least one coextrusion layer comprising a nitrogen- or oxygen-containing polymer, which may have been provided with the flame retardants and aging inhibitors or carbon blacks disclosed herein, in addition to a layer of polypropylene copolymer.

Suitable flame retardants are essentially only hydroxides of aluminum and of magnesium. A preferred filler as flame retardant is magnesium hydroxide.

Additions of further flame retardants, though possible, are preferably not made. Examples are polyphosphates and nitrogen compounds. In some cases, however, they are sensitive to water; this may lead to corrosion or to deterioration in electrical properties such as the breakdown voltage. Influence of water is not significant for a wrapping foil in the passenger compartment. In the engine compartment, however, the wrapping foil may become hot and wet. Examples of nitrogen-containing flame retardants are dicyandiamide, melamine cyanurate, and sterically hindered amines such as, for example, the class of the HA(L)S. Red phosphorus can be used but preferably is not (in other words, the amount is zero or not flame-effective), since its processing is hazardous (self-ignition of liberated phosphine during incorporation into the polymer by mixing; even in the case of coated phosphorus the amount of phosphine produced may still be enough to pose a health hazard to operatives). Moreover, when red phosphorus is used, it is not possible to produce colored products, but only black and brown products. Examples of nitrogen-containing flame retardants are melamine, ammeline, melam, melamine cyanurate. Red phosphorus likewise acts synergistically when using magnesium hydroxide, as is known from the literature. For the reasons specified above, however, it is not used. Organic and inorganic phosphorus compounds in the form of the known flame retardants such as those, for example, based on triaryl phosphate or polyphosphate salts act antagonistically. In the preferred embodiments, therefore, bound phosphorus is omitted, unless it is in the form of phosphites with an aging inhibition effect. These ought not to exceed the chemically bonded phosphorus content of 0.5 phr.

The flame retardant may have been provided with a coating, which in the case of the compounding operation may also be applied subsequently. Suitable coatings are silanes such as vinylsilane or free fatty acids (or derivatives thereof) such as stearic acid, silicates, borates, aluminum compounds, phosphates, titanates, or else chelating agents. The amount of free fatty acid or derivative thereof is preferably between 0.3% and 1% by weight.

Particular preference is given to ground magnesium hydroxides, examples being brucite (magnesium hydroxide), kovdorskites (magnesium hydroxide phosphate), hydromagnesite (magnesium hydroxycarbon), and hydrotalcite (magnesium hydroxide with aluminum and carbonate in the crystal lattice), particular preference being given to the use of brucite. Admixtures of magnesium carbonates such as, for example, dolomite [CaCO₃.MgCO₃, Mᵣ 184.41], magnesite (MgCO₃), and huntite [CaCO₃.3MgCO₃, Mᵣ 353.05] are allowable.

As far as aging is concerned, the presence of calcium carbonate (as a compound or in the form of a mixed crystal of calcium and magnesium and carbonate) even proves advantageous, with a fraction of 1% to 4% by weight calcium carbonate being regarded as favorable (the analytical calcium content is converted to pure calcium carbonate). In the case of brucite, calcium and carbonate are present, in numerous deposits, as an impurity in the form of chalk, dolomite, huntite or hydrotalcite, but can also be mixed purposively into the magnesium hydroxide. The positive effect is possibly based on the neutralization of acids. Such acids come about, for example, from magnesium chloride, which is generally encountered as a catalyst residue in polyolefins (from the Spheripol process, for example). Acidic constituents may likewise migrate from the adhesive coating into the foil and hence impair aging. Admixing calcium stearate allows an effect to be achieved which is similar to that achieved through calcium carbonate; however, adding larger amounts lowers the bond strength of the adhesive coating in such winding tapes and, in particular, lowers the adhesion of an adhesive layer of this kind to the reverse face of the wrapping foil.

Particularly suitable magnesium hydroxide is that having an average particle size of more than 2 μm, the reference being to the median average (d₅₀ determined by laser light scattering by the Cilas method), and in particular of greater than or equal to 4 μm. The specific surface area (BET) is preferably below 4 m²/g (DIN 66131/66132). Customary wet-precipitated magnesium hydroxides are finely divided: in general the average particle size is 1 μm or below, the specific surface area 5 m²/g or more. The upper limit on the particle size distribution, d₉₇, is preferably not above 20 μm, so as to prevent the occurrence of holes in the foil and embrittlement. Therefore the magnesium hydroxide is preferably screened. The presence of particles with a diameter of 10 to 20 μm gives the foil a pleasing matt appearance.

The preferred particle morphology is irregularly spherical, similar to that of river pebbles. It is obtained preferably by grinding. Particular preference is given to magnesium hydroxide which has been produced by dry grinding in the presence of a free fatty acid, especially stearic acid. The fatty acid coating which forms enhances the mechanical properties of mixtures of magnesium hydroxide and polyolefins and reduces magnesium carbonate bloom. The use of a fatty acid salt (sodium stearate, for example) is likewise possible but has the drawback that the wrapping foil produced therefrom exhibits increased conductivity in the presence of moisture, which is deleterious for applications in which the wrapping foil also takes on the function of an insulating tape. In the case of synthetically precipitated magnesium hydroxide the fatty acid is always added in salt form, owing to the water solubility. This is another reason why for the wrapping foil of the invention a ground magnesium hydroxide is preferred over a precipitated one.

Less preferred are aluminum hydroxide and magnesium hydroxide in platelet form. This applies to regular platelets (for example hexahedrons) and irregular platelets.

To the skilled worker the use of finely divided synthetic magnesium hydroxide is obvious, since it is highly pure and its flame retardancy is better than in the case of large particles. Surprisingly it has been found that compounds formed from ground magnesium hydroxide with relatively large spherical particles have better processing properties in a calendering and extrusion operation than compounds formed from ground magnesium hydroxide with small, platelet-shaped particles. Finely divided platelet-shaped magnesium hydroxide produces substantially higher melt viscosities than larger spherical magnesium hydroxide. The problem may be countered using polymers with a high melt index (MFI), although this impairs the mechanical stability of the melt, which is particularly important for blown-film extrusion and calendering. In the preferred embodiment the sheet is easier to remove from the rolls on the calender, or the bubble in the case of blown-film extrusion stands up better (no tearing of the melt bubble), but the flame retardancy is somewhat poorer than in the case of synthetic magnesium hydroxide, as is preferred by the skilled worker. This can be countered by raising the filler content, although that presupposes a particularly soft polymer. This may be a soft ethylene homopolymer or ethylene copolymer, the foil manufactured therefrom being preferably crosslinked in order to increase the thermal stability. The specific solution provided by this invention to the problem is a particularly soft polypropylene copolymer as set out above. This specific polymer makes it possible to a particular extent to use high amounts of filler and even higher in the case of ground magnesium hydroxide having a relatively high d₅₀ value, without the wrapping foil becoming too stiff and inflexible for application, and requires no crosslinking. For applications under the influence of high service temperature the traces of heavy metal in synthetic magnesium hydroxide may adversely affect aging, which is prevented through the use of the specific aging inhibitor combinations specified below.

The amount of the flame retardants is chosen such that the wrapping foil is flame-retardant, i.e., slow burning. The flame spread rate according to FMVSS 302 with a horizontal sample is preferably below 200 mm/min, more preferably below 100 mm/min; in one outstanding embodiment of the wrapping foil it is self-extinguishing under these test conditions. The oxygen index (LOI) is preferably above 20%, in particular above 23%, and more preferably above 27%. The fraction of metal hydroxide is above 120 phr, preferably above 150 phr.

For processing, the following techniques are preferred and claimed:
Mixing of polymer and filler in a compounder in batch operation or continuously (from Banbury for example); preferably part of the filler is added when another part has already been homogenized with the polymer.
Mixing of polymer and filler in a twin-screw extruder, part of the filler being used to prepare a preliminary compound which in a second compounding step is mixed with the remainder of the filler.
Mixing of polymer and filler in a twin-screw extruder, the filler being fed into the extruder not at one point but rather in at least two zones, by using a side feeder, for example.

Further additives customary in the case of films, such as fillers, pigments, aging inhibitors, nucleating agents, impact modifiers or lubricants, et cetera, can be used to produce the wrapping foil. These additives are described for example in “Kunststoff Taschenbuch”, Hanser Verlag, edited by H. Saechtling, 28th edition or “Plastic Additives Handbook”, Hanser-Verlag, edited by H. Zweifel, 5th edition. In the remarks below, the respective CAS Reg. No. is used in order to avoid chemical names that are difficult to understand.

The main objective of the present invention is the absence of halogens and volatile plasticizers in conjunction with high flame retardancy and flexibility. As stated, the thermal requirements are going up, so that in addition the intention is to achieve an increased resistance with respect to conventional PVC wrapping foils or the PVC-free foil-based winding tapes that are being trialed. The present invention will therefore be described with reference to this in detail below.

The wrapping foil of the invention has a thermal stability of at least 105° C. after 3000 hours, which means that after this storage there is still a breaking elongation of at least 100%. The foil ought further to have a breaking elongation of at least 100% after 20 days' storage at 136° C. (accelerated test) or a heat resistance of 170° C. (30 minutes). In one outstanding form, with the antioxidants described and optionally also with a metal deactivator, 125° C. after 2000 hours or even 125° C. after 3000 hours is attained. Conventional PVC wrapping foils based on DOP have a heat stability of 85° C. (passenger compartment), while high-performance products based on polymer plasticizer attain 105° C. (engine compartment).

Furthermore, the wrapping foil must be compatible with a polyolefin-based cable sheathing; in other words, after the cable/wrapping foil assembly has been stored, there must be neither embrittlement of the wrapping foil nor of the cable insulation. Through the selection of one or more appropriate antioxidants it is possible to obtain a compatibility at 105° C., preferably at 125° C. (2000 hours, in particular 3000 hours) and a short-term thermal stability of 140° C. (168 hours).

A further prerequisite for adequate short-term thermal stability and heat resistance is a sufficient melting point on the part of the polyolefin (at least 120° C.), and adequate mechanical stability of the melt somewhat above the crystallite melting point. It is, however, the aging stabilization which is decisive for obtaining oxidative resistance above 140° C., and this is achieved in particular by means of secondary antioxidants such as phosphites.

Compatibility between wrapping foil and the other cable-harness components, such as plugs and fluted tubes, is likewise desirable and can likewise be achieved by adapting the formulas, particularly with respect to the additives. A negative example that may be recited is the combination of an unsuitable polypropylene wrapping foil with a copper-stabilized polyamide fluted tube; in this case, both the fluted tube and the wrapping foil have undergone embrittlement after 3000 hours at 105° C.

In order to achieve effective aging stability and compatibility the use of the correct aging inhibitors is assigned a particular role. In this context it is also necessary to take account of the total amount of stabilizer, since in previous experiments on the production of such winding tapes aging inhibitors were used not at all or only at below 0.3 phr (x phr denotes x parts per 100 parts of polymer or polymer blend), as is usually also the case for production of other foils. The winding tapes of the invention should contain at least 4 phr of a primary antioxidant or, preferably, at least 0.3 phr, in particular at least 1 phr, of a combination of primary and secondary antioxidants, it also being possible for the primary and secondary antioxidant function to be united in one molecule, and the amounts stated not including optional stabilizers such as metal deactivators or light stabilizers. In one preferred embodiment the fraction of secondary antioxidant is more than 0.3 phr. Stabilizers for PVC products cannot be transferred to polyolefins. Secondary antioxidants break down peroxides and are therefore used as part of aging inhibitor packages in the case of diene elastomers. Surprisingly it has been found that a combination of primary antioxidants (for example, sterically hindered phenols or C-radical scavengers such as CAS 181314-48-7) and secondary antioxidants (for example, sulfur compounds, phosphites or sterically hindered amines), it also being possible for both functions to be united in one molecule, achieves the stated object in the case of diene-free polyolefins such as polypropylene as well. Particularly preferred is the combination of primary antioxidant, preferably sterically hindered phenols having a molecular weight of more than 500 g/mol (especially >700 g/mol), with a phosphitic secondary antioxidant (particularly with a molecular weight >600 g/mol). Phosphites or a combination of primary and two or more secondary aging inhibitors have not been used to date in wrapping foils comprising polypropylene copolymers. The combination of a low-volatility primary phenolic antioxidant and one secondary antioxidant each from the class of the sulfur compounds (preferably with a molecular weight of more than 400 g/mol, especially >500 g/mol) and from the class of the phosphites is suitable, and in this case the phenolic, sulfur-containing and phosphitic functions need not be present in three different molecules; instead, more than one function may also be united in one molecule.

### EXAMPLES

Phenolic function:

CAS 6683-19-8, 2082-79-3, 1709-70-2, 36443-68-2, 1709-70-2, 34137-09-2, 27676-62-6, 40601-76-1, 31851-03-3, 991-84-4

Sulfur-containing function:

CAS 693-36-7, 123-28-4, 16545-54-3, 2500-88-1

Phosphitic function:

CAS 31570-04-4, 26741-53-7, 80693-00-1, 140221-14-3, 119345-01-6, 3806-34-6, 80410-33-9, 14650-60-8, 161717-32-4

Phenolic and sulfur-containing function:

CAS 41484-35-9, 90-66-4, 110553-27-0, 96-96-5, 41484

Phenolic and aminic function:

CAS 991-84-4, 633843-89-0

Aminic function:

CAS 52829-07-9, 411556-26-7, 129757-67-1, 71878-19-8, 65447-77-0

The combination of CAS 6683-19-8 (for example, Irganox 1010) with thiopropionic esters CAS 693-36-7 (Irganox PS 802) or 123-28-4 (Irganox PS 800) with CAS 31570-04-4 (Irgafos 168) is particularly preferred. Preference is given to a combination in which the fraction of secondary antioxidant exceeds that of the primary antioxidant. In addition it is possible to add metal deactivators in order to complex traces of heavy metal, which may catalytically accelerate aging. Examples are CAS 32687-78-8, 70331-94-1, 6629-10-3, ethylenediaminetetraacetic acid, N,N′-disalicylidene-1,2-diaminopropane or commercial products such as 3-(N-salicylol)amino-1,2,4-triazole (Palmarole ADK STAB CDA-1), N,N′-bis[3-(3′,5′-di-tert-butyl-4′-hydroxyphenyl)propionyl]hydrazide (Palmarole MDA.P.10) or 2,2′-oxamido-bis[ethyl 3-(tert-butyl-4-hydroxyphenyl)propionate] (Palmarole MDA.P.11).

The selection of the stated aging inhibitors is particularly important for the wrapping foil of the invention, since with phenolic antioxidants, alone or even in combination with sulfur-containing costabilizers, it is not generally possible to obtain products which conform to the art. In calender processing, where on the rolls a relatively long-lasting ingress of atmospheric oxygen is unavoidable, the concomitant use of phosphite stabilizers proves virtually inevitable for sufficient thermal aging stability on the part of the product. Even in the case of extrusion processing, the addition of phosphites is still manifested positively in the aging test on the product. For the phosphite stabilizer an amount of at least 0.1 phr, preferably at least 0.3 phr, is preferred. Particularly when using natural magnesium hydroxides such as brucite it is possible, as a result of migratable metal impurities such as iron, manganese, chromium or copper, for aging problems to arise, which can be avoided only through abovementioned knowledge of the correct combination and amount of aging inhibitors. As remarked above, ground brucite has a number of technical advantages over precipitated magnesium hydroxide, so that the combination with antioxidants as described is particularly sensible. For applications involving a high temperature load (for example, for use as cable wrapping foil in the engine compartment of motor vehicles or as an insulating winding on magnet coils in TV or PC screens) an embodiment is preferred which besides the antioxidants also includes a metal deactivator.

The wrapping foil of the invention is preferably pigmented, especially black. Coloring may be carried out in the base film, in the adhesive layer or in any other layer. The use of organic pigments or dyes in the wrapping foil is possible, preference being given to the use of carbon black. The carbon black fraction is preferably at least 5 phr, in particular at least 10 phr, since surprisingly it proves to have a significant influence on the fire performance. The thermal aging stability is, surprisingly, higher when the carbon black is added (in the form of a masterbatch, for example) only after the polypropylene polymer has been mixed with the aging inhibitors (antioxidants). This advantage can be utilized by first compounding polymer, aging inhibitor, and filler with one another and only adding the carbon black, as a masterbatch, to an extruder in the foil production installation (calender or extruder). An additional benefit is that, in the event of a product changeover on the compounder (plunger compounder or extruder such as twin-screw extruder or planetary roller extruder), there is no need for costly and inconvenient cleaning to remove carbon black residues. Surprisingly for the skilled worker, even unusually large amounts of carbon black masterbatch can be added without problems on the film installation, such amounts being not only 1 to 2 phr but even 15 to 30 phr. As carbon black it is possible to use all of the types, such as gas black, acetylene black, furnace black and lamp black, for example, preference being given to lamp black, despite the fact that furnace blacks are usual for the coloring of films. For optimum aging, preference is given to carbon black grades having a pH in the range from 6 to 8.

The wrapping foil is produced on a calender or by extrusion such as, for example, in a blowing or casting operation. These processes are described for example in Ullmann's Encyclopedia of Industrial Chemistry, 6th ed., Wiley-VCH 2002. The compound comprising the main components or all of the components can be produced in a compounder such as kneading apparatus (for example, a plunger compounder) or extruder (for example, a twin-screw or planetary roll extruder) and then converted into a solid form (granules, for example) which are then melted in a foil extrusion plant or an extruder, compounder or roll mill of a calender installation, and processed further. The inventive amounts of filler have been employed to date not for foils but only for thick-wall products (for example, cable insulations above 300 μm, or injection moldings); consequently, in the case of the thin foil of the invention, inhomogeneities (defects) easily arise, and sharply reduce the breakdown voltage. The mixing operation must therefore be performed thoroughly enough that the foil manufactured from the compound attains a breakdown voltage of at least 3 kV/100 μm, preferably at least 5 kV/100 μm. It is preferred to produce compound and foil in one operation. The melt is supplied from the compounder directly to an extrusion plant or a calender, but may if desired pass through auxiliary installations such as filters, metal detectors or roll mills. In the course of the production operation the foil is oriented as little as possible, in order to achieve good hand tearability, low force value at 1% elongation, and low contraction. For this reason, the calendering process is particularly preferred. The high filler content produces such high viscosities that for this reason as well the calender process is more suitable. Although polymers based on ethylene-vinyl acetate or ethylene-acrylate have been described with particular frequency in patents, on account of their improved LOI as compared with standard polyolefins, they are unsuitable for calender processing, even as an additive in relatively large amounts, owing to the severity of sticking on the calender rolls.

The contraction of the wrapping foil in machine direction after hot storage (30 minutes in an oven at 125° C., lying on a layer of talc) is less than 5%, preferably less than 3%.

The mechanical properties of the wrapping foil of the invention are situated preferably in the following ranges:
breaking elongation in md (machine direction) from 300% to 1000%, more preferably from 500% to 800%,
breaking strength in md in the range from 4 to 15, more preferably from 5 to 8 N/cm,

the foil having been cut to size using sharp blades in order to determine the data.

In the preferred embodiment the wrapping foil is provided on one or both sides, preferably one side, with a sealing or pressure-sensitive adhesive coating, in order to avoid the need for the wound end to be fixed by means of an adhesive tape, wire or knot. The amount of the adhesive layer is in each case 10 to 40 g/m², preferably 18 to 28 g/m² (that is, the amount after removal of water or solvent, where necessary; the numerical values also correspond approximately to the thickness in μm). In one case with adhesive coating the figures given here for the thickness and for mechanical properties dependent on thickness refer exclusively to the polypropylene-containing layer of the wrapping foil, without taking into account the adhesive layer or other layers which are advantageous in connection with adhesive layers. The coating need not cover the whole area, but may also be configured for partial coverage. An example that may be mentioned is a wrapping foil with a pressure-sensitively adhesive strip at each of the side edges. This strip can be cut off to form approximately rectangular sheets, which are adhered to the cable bundle by one adhesive strip and are then wound until the other adhesive strip can be bonded to the reverse of the wrapping foil. A hoselike envelope of this kind, similar to a sleeve form of packaging, has the advantage that there is virtually no deterioration in the flexibility of the cable harness as a result of the wrapping.

Suitable adhesives include all customary types, especially those based on rubber. Rubbers of this kind may be, for example, homopolymers or copolymers of isobutylene, of 1-butene, of vinyl acetate, of ethylene, of acrylic esters, of butadiene or of isoprene. Particularly suitable formulas are those based on polymers themselves based on acrylic esters, vinyl acetate or isoprene.

In order to optimize the properties it is possible for the self-adhesive mass employed to have been blended with one or more additives such as tackifiers (resins), plasticizers, fillers, flame retardants, pigments, UV absorbers, light stabilizers, aging inhibitors, photoinitiators, crosslinking agents or crosslinking promoters. Tackifiers are, for example, hydrocarbon resins (for example, polymers based on unsaturated C5 or C9 monomers), terpene-phenolic resins, polyterpene resins formed from raw materials such as α- or β-pinene, for example, aromatic resins such as coumarone-indene resins, or resins based on styrene or α-methylsytrene, such as rosin and its derivatives, disproportionated, dimerized or esterified resins, for example, such as reaction products with glycol, glycerol or pentaerythritol, for example, to name only a few, and also further resins (as recited, for example, in Ullmanns Enzylopädie der technischen Chemie, Volume 12, pages 525 to 555 (4th ed.), Weinheim). Preference is given to resins without easily oxidizable double bonds, such as terpene-phenolic resins, aromatic resins, and, with particular preference, resins prepared by hydrogenation, such as, for example, hydrogenated aromatic resins, hydrogenated polycyclopentadiene resins, hydrogenated rosin derivatives or hydrogenated terpene resins.

Examples of suitable fillers and pigments include titanium dioxide, calcium carbonate, zinc carbonate, zinc oxide, silicates or silica. Suitable admixable plasticizers are, for example, aliphatic, cycloaliphatic and aromatic mineral oils, diesters or polyesters of phthalic acid, trimellitic acid or adipic acid, liquid rubbers (for example, nitrile rubbers or polyisoprene rubbers of low molecular mass), liquid polymers of butene and/or isobutene, acrylic esters, polyvinyl ethers, liquid resins and soft resins based on the raw materials of tackifier resins, lanolin and other waxes or liquid silicones. Examples of crosslinking agents include isocyanates, phenolic resins or halogenated phenolic resins, melamine resins and formaldehyde resins. Suitable crosslinking promoters are, for example, maleimides, allyl esters such as triallyl cyanurate, and polyfunctional esters of acrylic and methacrylic acid. Examples of aging inhibitors include sterically hindered phenols, which are known, for example, under the trade name Irganox™.

Crosslinking is advantageous, since the shear strength (expressed as holding power, for example) is increased and hence the tendency toward deformation in the rolls on storage (telescoping or formation of cavities, also called gaps) is reduced. Exudation of the pressure-sensitive adhesive mass, as well, is reduced. This is manifested in tack-free side edges of the rolls and tack-free edges in the case of the wrapping foil wound spirally around cables. The holding power is preferably more than 150 min.

The bond strength to steel ought to be situated in the range from 1.5 to 3 N/cm.

In summary the preferred embodiment has on one side a solvent-free self-adhesive mass which has come about as a result of coextrusion, melt coating or dispersion coating. Dispersion adhesives are preferred, especially polyacrylate-based ones.

Advantageous is the use of a primer layer between wrapping foil and adhesive mass in order to improve the adhesion of the adhesive mass on the wrapping foil and hence to prevent transfer of adhesive to the reverse of the foil during unwinding of the rolls.

Primers which can be used are the known dispersion- and solvent-based systems based for example on isoprene or butadiene rubber and/or cyclo rubber. Isocyanates or epoxy resin additives improve the adhesion and in part also increase the shear strength of the pressure-sensitive adhesive. Physical surface treatments such as flaming, corona or plasma, or coextrusion layers, are likewise suitable for improving the adhesion. Particular preference is given to applying such methods to solvent-free adhesive layers, especially those based on acrylate.

The reverse face can be coated with known release agents (blended where appropriate with other polymers). Examples are stearyl compounds (for example, polyvinyl stearylcarbamate, stearyl compounds of transition metals such as Cr or Zr, and ureas formed from polyethyleneimine and stearyl isocyanate), polysiloxanes (for example, as a copolymer with polyurethanes or as a graft copolymer on polyolefin), and thermoplastic fluoropolymers. The term stearyl stands as a synonym for all linear or branched alkyls or alkenyls having a C number of at least 10, such as octadecyl, for example.

Descriptions of the customary adhesive masses and also reverse-face coatings and primers are found for example in “Handbook of Pressure Sensitive Adhesive Technology”, D. Satas, (3rd edition). The stated reverse-phase primer coatings and adhesive coatings are possible in one embodiment by means of coextrusion.

The configuration of the reverse face of the foil may also, however, serve to increase the adhesion of the adhesive mass to the reverse face of the wrapping foil (in order to control the unwind force, for example). In the case of polar adhesives such as those based on acrylate polymers, for example, the adhesion of the reverse face to a foil based on polypropylene polymers is often not sufficient. For the purpose of increasing the unwind force an embodiment is claimed in which the polar reverse-face surfaces are achieved by corona treatment, flame pretreatment or coating/coextrusion with polar raw materials. Claimed alternatively is a wrapping foil in which the log product has been conditioned (stored under hot conditions) prior to slitting. Both processes may also be employed in combination. The wrapping foil of the invention preferably has an unwind force of 1.2 to 6.0 N/cm, very preferably of 1.6 to 4.0 N/cm, and in particular 1.8 to 2.5 N/cm, at an unwind speed of 300 mm/min. The conditioning is known in the case of PVC winding tapes, but for a different reason. In contradistinction to partially crystalline polypropylene copolymer films, plasticized PVC films have a broad softening range and, since the adhesive mass has a lower shear strength, owing to the migrative plasticizer, PVC winding tapes tend toward telescoping. This unadvantageous deformation of the rolls, in which the core is forced out of the rolls to the side, can be prevented if the material is stored for a relatively long time prior to slitting or is subjected briefly to conditioning (storage under hot conditions for a limited time). In the case of the process of the invention, however, the purpose of the conditioning is to increase the unwind force of material with an apolar polypropylene reverse face and with a polar adhesive mass, such as polyacrylate or EVA, since this adhesive mass exhibits extremely low reverse-face adhesion to polypropylene in comparison to PVC. An increase in the unwind force by conditioning or physical surface treatment is unnecessary with plasticized PVC winding tapes, since the adhesive masses normally used possess sufficiently high adhesion to the polar PVC surface. In the case of polyolefin wrapping foils the significance of reverse-face adhesion is particularly pronounced, since because of the higher force at 1% elongation (owing to the flame retardant and the absence of conventional plasticizers) a much higher reverse-face adhesion, and unwind force, is necessary, in comparison to PVC film, in order to provide sufficient stretch during unwind for the application. The preferred embodiment of the wrapping foil is therefore produced by conditioning or physical surface treatment in order to achieve outstanding unwind force and stretch during unwind, the unwind force at 300 mm/min being higher preferably by at least 50% than without such a measure.

In the case of an adhesive coating, the wrapping foil is preferably stored beforehand for at least 3 days, more preferably at least 7 days, prior to coating, in order to achieve post-crystallization, so that the rolls do not acquire any tendency toward telescoping (probably because the foil contracts on crystallization). Preferably the foil on the coating installation is guided over heated rollers for the purpose of leveling (improving the planar lie), which is not customary for PVC wrapping foils.

Normally, polyethylene and polypropylene films cannot be torn into or torn off by hand. As partially crystalline materials, they can be stretched with ease and therefore have a high breaking elongation, generally of well above 500%. When attempts are made to tear such films what occurs, rather than tearing, is stretching. Even high forces may not necessarily overcome the typically high rupture forces. Even if this does occur, the tear which is produced does not look good and cannot be used for bonding, since a thin, narrow “tail” is formed at either end. Nor can this problem be eliminated by means of additives, even if large amounts of fillers reduce the breaking elongation. If polyolefin films are biaxially stretched the breaking elongation is reduced by more than 50%, to the benefit of tearability. Attempts to transfer this process to soft wrapping foils failed, however, since there is a considerable increase in the 1% force value and the force/elongation curve becomes considerably more steep. A consequence of this is that the flexibility and conformability of the wrapping foil are drastically impaired. Moreover, it is found that foils with such high filler content are virtually impossible to stretch in industrial production, owing to a high number of tears. When more than 120 phr of metal hydroxide are used, the hand tearability of polyolefinic wrapping foils is very good. It can be improved further by way of the slitting technique when the rolls are being converted. In the course of the production of rolls of wrapping foils, rough slit edges are produced which, viewed microscopically, form cracks in the foil, which then evidently promote tear propagation. This is possible in particular through the use of a crush slitting with blunt rotating knives, or rotating knives with a defined sawtooth, on product in bale form (jumbo rolls, high-length rolls) or by means of a parting slitting with fixed blades or rotating knives on product in log form (rolls in production width and conventional selling length). The breaking elongation can be adjusted by appropriate grinding of the blades and knives. Preference is given to the production of log product with parting slitting using blunt fixed blades. By cooling the log rolls sharply prior to slitting it is possible to improve still further the formation of cracks during the slitting operation. In the preferred embodiment the breaking elongation of the specially slit wrapping foil is lower by at least 30% than when it is slit with sharp blades. In the case of the particularly preferred foils that are slit with sharp blades the breaking elongation is 500% to 800%; in the embodiment of the foil whose side edges are subjected to defined damage in the course of slitting, it is between 200% and 500%.

In order to increase the unwind force, the log product can be subjected to storage under hot conditions beforehand. Conventional winding tapes with cloth, web or film carriers (PVC for example) are slit by shearing (between two rotating knives), parting (fixed or rotating knives are pressed into a rotating log roll of the product), blades (the web is divided in the course of passage through sharp blades) or crush (between a rotating knife and a roller).

The purpose of slitting is to produce saleable rolls from jumbo or log rolls, but not to produce rough slit edges for the purpose of easier hand tearability. In the case of PVC wrapping foils the parting slit is entirely conventional, since the process is economic in the case of soft foils. In the case of PVC material, however, hand tearability is given, since, unlike polypropylene, PVC is amorphous and therefore is not stretched on tearing, only elongated a little. So that the PVC foils do not tear too easily, attention must be paid to appropriate gelling in the course of production of the foil, which goes against an optimum production speed; in many cases, therefore, instead of standard PVC with a K value of 63 to 65, material of higher molecular weight is used, corresponding to K values of 70 or more. With the polypropylene wrapping foils of the invention, therefore, the reason for the parting is different than in the case of those made of PVC.

The wrapping foil of the invention is outstandingly suitable for the wrapping of elongate material such as ventilation pipes, field coils or cable looms in vehicles.

The wrapping foil of the invention is likewise suitable for other applications, such as, for example, for ventilation pipes in air-conditioning installation, since the high flexibility ensures good conformability to rivets, beads and folds. Present-day occupational hygiene and environmental requirements are met, because halogenated raw materials are not used; the same also applies to volatile plasticizers, even though the amounts are so small that the fogging number is more than 90%. Absence of halogen is extremely important for the recovery of heat from wastes which includes such winding tapes (for example, incineration of the plastics fraction from vehicle recycling). The product of the invention is halogen-free in the sense that the halogen content of the raw materials is so low that it plays no part in the flame retardancy. Halogens in trace amounts, such as may occur as a result of impurities in-process additives (fluoroelastomer) or as residues of catalysts (from the polymerization of polymers, for example), remain disregarded. The omission of halogens is accompanied by the quality of easy flammability, which is not in accordance with the safety requirements in electrical applications such as household appliances or vehicles. The problem of deficient flexibility when using customary PVC substitute materials such as polypropylene, polyethylene, polyesters, polystyrene, polyamide or polyimide for the wrapping foil is solved in the underlying invention not by means of volatile plasticizers but instead by the use of a mixture of a PP copolymer with a polyolefin of low flexural modulus or the use of a PP polymer with a low flexural modulus. It is therefore particularly surprising that even the use of fillers with a flame retardancy effect, which—as is known—drastically reduce the flexibility down to the point of complete embrittlement, is possible. The flexibility is of outstanding significance, since when applied to wires and cables the foil must be wound not only in spiral form but also in crease-free, curve-flexible fashion at branching points, plugs or fastening clips. A further desire is for the wrapping foil to pull the cable strand together elastically. This behavior is also necessary for the sealing of ventilation pipes. These mechanical properties can be achieved only by a soft, flexible winding tape. The problem of achieving the necessary flexibility in spite of relatively large amounts of flame retardants is solved with the wrapping foil of the invention, despite the fact that with a polyolefin winding tape the problem is disproportionately more difficult to solve than in the case of PVC, since with PVC there is little or no need for flame retardants, and the flexibility is easily achieved through conventional plasticizers.

### Test Methods

The measurements are carried out under test conditions of 23±1° C. and 50±5% relative humidity.

The density of the polymers is determined in accordance with ISO 1183 and the flexural modulus in accordance with ISO 178 and expressed in g/cm³ and MPa respectively. (The flexural modulus in accordance with ASTM D790 is based on different specimen dimensions, but the result is comparable as a number.) The melt index is tested in accordance with ISO 1133 and expressed in g/10 min. The test conditions are, as is the market standard, 230° C. and 2.16 kg for polymers containing crystalline polypropylene and 190° C. and 2.16 kg for polymers containing crystalline polyethylene. The crystallite melting point (Tcr) is determined by DSC in accordance with MTM 15902 (Basell method) or ISO 3146.

The average particle size of the filler is determined by means of laser light scattering by the Cilas method, the critical figure being the d₅₀ median value.

The specific surface area (BET) of the filler is determined in accordance with DIN 66131/66132.

The tensile elongation behavior of the wrapping foil is determined on type 2 test specimens (rectangular test strips 150 mm long and, as far as possible, 15 mm wide) in accordance with DIN EN ISO 527-3/2/300 with a test speed of 300 mm/min, a clamped length of 100 mm and a pretensioning force of 0.3 N/cm. In the case of specimens with rough slit edges, the edges should be tidied up with a sharp blade prior to the tensile test. In deviation from this, for determining the force or tension at 1% elongation, measurement is carried out with a test speed of 10 mm/min and a pretensioning force of 0.5 N/cm on a model Z 010 tensile testing machine (manufacturer: Zwick). The testing machine is specified since the 1% value may be influenced somewhat by the evaluation program. Unless otherwise indicated, the tensile elongation behavior is tested in machine direction (MD). The force is expressed in N/strip width and the tension in N/strip cross section, the breaking elongation in %. The test results, particularly the breaking elongation (elongation at break), must be statistically ascertained by means of a sufficient number of measurements.

The bond strengths are determined at a peel angle of 180° in accordance with AFERA 4001 on test strips which (as far as possible) are 15 mm wide. AFERA standard steel plates are used as the test substrate, in the absence of any other substrate being specified.

The thickness of the wrapping foil is determined in accordance with DIN 53370. Any pressure-sensitive adhesive layer is subtracted from the total thickness measured.

The holding power is determined in accordance with PSTC 107 (10/2001), the weight being 20 N and the dimensions of the bond area being 20 mm in height and 13 mm in width.

The unwind force is measured at 300 mm/min in accordance with DIN EN 1944.

The hand tearability cannot be expressed in numbers, although breaking force, breaking elongation and impact strength under tension (all measured in machine direction) are of substantial influence.

Evaluation:

+++=very easy,

++=good,

+=still processable,

−=difficult to process,

−−=can be torn only with high application of force; the ends are untidy,

−−−=unprocessable

The fire performance is measured in accordance with MVSS 302 with the sample horizontal. In the case of a pressure-sensitive adhesive coating on one side, that side faces up. As a further method, testing of the oxygen index (LOI) is performed. Testing for this purpose takes place under the conditions of JIS K 7201.

The heat stability is determined by a method based on ISO/DIN 6722. The oven is operated in accordance with ASTM D 2436-1985 with 175 air changes per hour. The test time amounts to 3000 hours. Test temperatures chosen are 85° C. (class A), 105° C. (similar to class B but not 100° C.), and 125° C. (class C). Accelerated aging takes place at 136° C., with the test being passed if the elongation at break is still at least 100% after 20 days' aging.

In the case of compatibility testing, storage under hot conditions is carried out on commercially customary leads (cables) with polyolefin insulation (polypropylene or radiation-crosslinked polyethylene) for motor vehicles. For this purpose, specimens are produced from 5 leads with a cross section of 3 to 6 mm² and a length of 350 mm, with wrapping foil, by wrapping with a 50% overlap. After the aging of the specimens in a forced-air oven for 3000 hours (conditions as for heat stability testing), the samples are conditioned at 23° C. and in accordance with ISO/DIN 6722 are wound by hand around a mandrel; the winding mandrel has a diameter of 5 mm, the weight has a mass of 5 kg, and the winding rate is 1 rotation per second. The specimens are subsequently inspected for defects in the wrapping foil and in the wire insulation beneath the wrapping foil. The test is failed if cracks can be seen in the wire insulation, particularly if this is apparent even before bending on the winding mandrel. If the wrapping foil has cracks or has melted in the oven, the test is likewise classed as failed. In the case of the 125° C. test, specimens were in some cases also tested at different times. The test time is 3000 hours unless expressly described otherwise in an individual case.

The short-term thermal stability is measured on cable bundles comprising 19 wires of type TW with a cross section of 0.5 mm², as described in ISO 6722. For this purpose the wrapping foil is wound with a 50% overlap onto the cable bundle, and the cable bundle is bent around a mandrel with a diameter of 80 mm and stored in a forced-air oven at 140° C. After 168 hours the specimen is removed from the oven and examined for damage (cracks).

To determine the heat resistance the wrapping foil is stored at 170° C. for 30 minutes, cooled to room temperature for 30 minutes and wound with at least 3 turns and a 50% overlap around a mandrel with a diameter of 10 mm. Thereafter the specimen is examined for damage (cracks).

In the case of the low-temperature test, the above-described specimen is cooled to −40° C. for 4 hours, in a method based on ISO/DIS 6722, and the sample is wound by hand onto a mandrel with a diameter of 5 mm. The specimens are examined for defects (cracks) in the adhesive tape.

The breakdown voltage is measured in accordance with ASTM D 1000. The number taken is the highest value for which the specimen withstands this voltage for one minute. This number is converted to a sample thickness of 100 μm.

### Example

A sample 200 μm thick withstands a maximum voltage of 6 kV for one minute: the calculated breakdown voltage amounts to 3 kV/100 μm.

The fogging number is determined in accordance with DIN 75201 A.

The examples which follow are intended to illustrate the invention without restricting its scope.

Contents:

Tabular compilation of the raw materials used for the experiments

Description of the inventive examples

Tabular compilation of the results of the inventive examples

Description of the comparative examples

Tabular compilation of the results of the comparative examples

Tabular compilation of the raw materials used for the experiments (the measurement conditions and units have in some cases been omitted; see Test methods)

| Raw material | Manufacturer | Description | Technical data |
|---|---|---|---|
| Polymer A | | EP-modified | Flexural modulus = 80 MPa, |
| | | random PP | MFI = 0.6, |
| | | copolymer from | Tcr = 142° C., |
| | | reactor cascade, | Density = 0.88, |
| | | gas-phase process | Breaking stress 23 MPa, |
| | | | Yield stress 6 MPa |
| Polymer B | | EP-modified | Flexural modulus = 80 MPa, |
| | | random PP | MFI = 8, |
| | | copolymer from | Tcr = 142° C., |
| | | reactor cascade, | Density = 0.88, |
| | | gas-phase process | Breaking stress 16 MPa, |
| | | | Yield stress 6 MPa |
| Polymer C | | EP-modified | Flexural modulus = 30 MPa, |
| | | random PP | MFI = 0.6, |
| | | copolymer from | Tcr = 141° C., |
| | | reactor cascade, | Density = 0.87, |
| | | gas-phase process | Breaking stress 10 MPa |
| Polymer D | | EP-modified | Flexural modulus = 400 MPa, |
| | | random PP | MFI = 0.8, |
| | | copolymer from a | Tcr = 140° C., |
| | | reactor, Sheripol | Density = 0.9, |
| | | process | Breaking stress 52 MPa |
| Cataloy KS-353 P | SKD Sunrise | EP-modified PP | Flexural modulus = 83 MPa, |
| | | homopolymer, | MFI = 0.45, |
| | | grafting in the | Tcr = 154° C., |
| | | Cataloy process | Density = 0.88, |
| | | | Breaking stress 10 MPa, |
| | | | Yield stress 6.2 MPa |
| Cataloy KS-021 P | SKD Sunrise | EP-modified PP | Flexural modulus = 228 MPa, |
| | | homopolymer, | MFI = 0.9, |
| | | grafting in the | Tcr = 154° C., |
| | | Cataloy process | Density = 0.89, |
| | | | Breaking stress 12 MPa, |
| | | | Yield stress 6.9 MPa |
| Lupolex 18E FA | Basell | LLDPE | Density = 0.919, MFI = 0.5 |
| Affinity PL 1840 | Dow Chem. | VLDPE | Density = 0.909, MFI = 1 |
| Exact 8201 | Exxon | LLDPE | Flexural modulus = 26 MPa, |
| | | (metallocene) | MFI = 1.1, |
| | | | Tcr = 67° C., |
| | | | Density = 0.88, |
| | | | Breaking stress 20 MPa |
| Epsyn 7506 | Copolymer | EPDM rubber | |
| Adflex KS 359 P | Basell | Ethylene-modified | Flexural modulus = 83 MPa, |
| | | polypropylene | MFI = 12, |
| | | homopolymer | Tcr = 154° C., |
| | | | Density = 0.88, |
| | | | Breaking stress 10 MPa, |
| | | | Yield stress 5.0 MPa |
| ESI DE 200 | Dow | Ethylene-styrene | |
| | | interpolymer | |
| Evaflex A 702 | DuPont | EEA | EA = 19%, MFI = 5 |
| Evaflex P 1905 | DuPont | EVA | VAc = 19%, MFI = 5 |
| Elvax 470 | DuPont | EVA | VAc = 18%, MFI = 0.7 |
| Evatane 2805 | Elf Atochem | EVA | VAc = 28%, MFI = 5 |
| Evatane 1005 | Elf Atochem | EVA | VAc = 14%, MFI = 0.7 |
| VN4 | | | |
| Escorene UL | Exxon | EVA | VAc = 19%, MFI = 1 |
| 00119 | | | |
| Escorene UL | Exxon | EVA | VAc = 33%, MFI = 21 |
| 02133 | | | |
| Vinnapas B 100 | Wacker | PVAc | VAc = 100% |
| Tuftec M-1943 | Asahi | Diene-styrene | |
| | Chemical | elastomer | |
| Magnifin H 5 | Martinswerk | Precipitated | d₅₀ = 1.35 μm, platelet- |
| | | magnesium | shaped, BET = 4 m²/g, |
| | | hydroxide | >99.8% magnesium |
| | | | hydroxide, <0.1% calcium |
| | | | carbonate |
| Magnifin H 5 GV | Martinswerk | Precipitated | d₅₀ = 1.35 μm, platelet- |
| | | magnesium | shaped, BET = 4 m²/g, |
| | | hydroxide | >99.8% magnesium |
| | | | hydroxide, <0.1% calcium |
| | | | carbonate, polymer coating |
| Kisuma 5 A | Kisuma | Precipitated | d₅₀ = 1.0 μm, platelet-shaped |
| | | magnesium | |
| | | hydroxide | |
| Brucite 15 μ | Lehmann & | Ground magnesium | d₅₀ =4 μm, d₉₇ = 18 μm, |
| | Voss | hydroxide | irregularly spherical, calcium |
| | | | carbonate content 2.4%, |
| | | | 0.5% stearic acid |
| Securoc B 10 | Incemin | Ground magnesium | d₅₀ =4 μm, d₉₇ = 18 μm |
| | | hydroxide | (screened), irregularly |
| | | | spherical, BET = 8 m²/g, |
| | | | 1.7% calcium carbonate, |
| | | | 94.3% magnesium hydroxide, |
| | | | 0.3% fatty acid |
| Magshizu N-3 | Konoshima | Precipitated | d₅₀ = 1.1 μm, platelet-shaped, |
| (Magseeds N-3) | Chemical | magnesium | BET = 3 m²/g, 2.5% fatty acid |
| | | hydroxide | coating |
| Martinal 99200- | Martinswerk | Aluminum | d₅₀ = 1.8 μm, hexagonally |
| 08 (Martinal | | hydroxide | platelet-shaped, BET = |
| OL 104 G | | | 4 m²/g, polymer coating |
| Exolit AP 750 | Clariant | Ammonium | |
| | | polyphosphate | |
| EDAP | Albright & | Ethylenediamine | |
| | Wilson | phosphate | |
| Flamestab NOR | Ciba-Geigy | Sterically hindered | |
| 116 | | amine (HAS) | |
| SH 3 | Dow | Calcium carbonate | |
| | Chemical | masterbatch | |
| DE 83 R | Great Lakes | Decabromodiphenyl | |
| | | oxide | |
| Antimony oxide | Great Lakes | Diantimony trioxide | |
| TMS | | | |
| Flammrurβ 101 | Degussa | Lamp black | pH = 7.5 |
| Seast 3 H | Tokai | | pH = 9.5 |
| | Carbon | | |
| Carbon Black | Shama | Furnace black | pH = 10 |
| FEF | Chemical | | |
| Petrothene PM | Equistar | Carbon black | pH = 9, 40% furnace black in |
| 92049 | | masterbatch | polyethylene |
| | | comprising furnace | |
| | | black | |
| Novaexcel F-5 | Rinkagaku/ | Red phosphorus | |
| | Phosphorous | | |
| | Chemical | | |
| A 0750 | Union | Aminosilane | Crosslinker |
| | Carbide | | |
| AMEO T | Hüls AG | Aminosilane | Crosslinker |
| Irganox 1010 | Ciba-Geigy | Primary antioxidant | Sterically hindered phenol |
| Irganox PS 800 | Ciba-Geigy | Secondary | Thiopropionic ester |
| | | antioxidant | |
| Irganox PS 802 | Ciba-Geigy | Secondary | Thiopropionic ester |
| | | antioxidant | |
| Sumilizer TPM | Sumitomo | Secondary | Thiopropionic ester |
| | | antioxidant | |
| Sumilizer TPL-R | Sumitomo | Secondary | Thiopropionic ester |
| | | antioxidant | |
| Sumilizer TP-D | Sumitomo | Secondary | Thiopropionic ester |
| | | antioxidant | |
| Irgafos 168 | Ciba-Geigy | Secondary | Phosphite |
| | | antioxidant | |
| Irganox MD 1024 | Ciba-Geigy | Metal deactivator | Heavy-metal scavenger |
| Primal PS 83D | Rohm & | Acrylate PSA | Dispersion PSA |
| | Häas | | |
| Acronal DS 3458 | BASF | Acrylate PSA | Hotmelt PSA |
| Rikidyne BDF | Vig te Qnos | Acrylate PSA | Solution PSA |
| 505 | | | |
| JB 720 | Johnson | Acrylate PSA | Dispersion PSA |
| Airflex EAF 60 | Air Products | EVA PSA | Dispersion PSA |
| Desmodur Z | Bayer | Isocyanate | Crosslinker |
| 4470 MPNX | | | |

PSA=pressure-sensitive adhesive

### Example 1

To produce the carrier film, 100 phr of polymer A, 10 phr of Vinnapas B 10, 165 phr of Magnifin H 5 GV, 10 phr of Flammruβ 101, 0.8 phr of Irganox 1010, 0.8 phr of Irganox PS 802 and 0.3 phr of Irgafos 168 are first compounded in a co-rotating twin-screw extruder. ⅓ of the Magnifin is added in each of zones 1, 3, and 5.

The compound melt is taken from the die of the extruder to a roll mill, from where it is passed through a strainer and subsequently fed via a conveyor belt into the nip of a calender of the “inverted L” type. With the aid of the calender rolls, a film having a smooth surface is formed in a width of 1500 mm and a thickness of 0.08 mm (80 μm) and is post-crystallized on heat-setting rolls. The film is stored for one week, leveled on the coating installation with rolls at 60° C. in order to improve the planar lie, and, following corona treatment, is coated with an aqueous acrylate PSA, Primal PS 83 D, by means of a coating knife, with an application rate of 24 g/m². The layer of adhesive is dried in a drying tunnel at 70° C.; the finished wrapping foil is wound to log rolls having a running length of 33 m on a 1-inch core (25 mm). Slitting takes place by parting the log rolls by means of a fixed blade with a not very acute angle (straight knife) into rolls 29 mm wide. As in the case of the subsequent examples as well, in the parting slitting an automatic device is used, for the reasons set out in the description of the invention.

In spite of the high filler fraction, this self-adhesive wrapping foil exhibits good flexibility. Moreover, even without the addition of an oxygen-containing polymer, very good fire properties are achieved. The aging stability and the compatibility with PP and PA cables and polyamide fluted tube are outstanding.

### Example 2

The preparation takes place as in example 1, with the following changes:

the compound is composed of 100 phr of polymer A, 125 phr of Martinal OL 104 G, 15 phr of Flammruβ 101, 0.8 phr of Irganox 1010, 0.1 phr of Irganox PS 802, 0.1 phr each of Sumilizer TPM, TPL-R, and TPD, 0.3 phr of Irgafos 168 and 1 phr of Irganox MD 1024. ½ of the Martinal was added in each of zones 1 and 5.

The carrier film produced from this compound is subjected to flame pretreatment on one side and, after 10 days' storage, is coated with Acronal DS 3458 by means of a roll applicator at 50 m/min. The temperature load on the carrier is reduced by means of a cooled counterpressure roller. The application rate is about 35 g/m². Appropriate crosslinking is achieved in-line, before winding, by irradiation with a UV unit equipped with 6 medium-pressure Hg lamps each of 120 W/cm. The irradiated web is wound to form log rolls with a running length of 33 m on a 1¼-inch core (31 mm). For the purpose of increasing the unwind force, the log rolls are conditioned in an oven at 60° C. for 5 hours. Slitting takes place by parting of the log rolls by means of a fixed blade (straight knife) into rolls 25 mm wide.

After 3 months' storage at 23° C. no aging inhibitor has been exuded from the film. Film from Example 1, in comparison, has a slight coating, which analysis shows to be Irganox PS 802.

This wrapping foil is distinguished by even greater flexibility than that from example 1. The fire spread rate is more than sufficient for the application. The film has a slightly matt surface. With respect to application, two fingers can be accommodated in the core, which facilitates application as compared with example 1.

### Example 3

Production takes place as in example 1, with the following changes:

the compound is composed of 80 phr of polymer A, 20 phr of Evaflex A 702, 125 phr of Securoc B 10, 0.2 phr of calcium carbonate, 10 phr of Flammruβ 101, 0.8 phr of Irganox 1010, 0.8 phr of Irganox PS 802 and 0.3 phr of Irgafos 168.

The film is corona-treated and on this side of the adhesive mass Rikidyne BDF 505 is applied (with the addition of 1% by weight of Desmodur Z 4470 MPA/X per 100 parts by weight of adhesive mass, calculated on the basis of solids content) at 23 g/m². The adhesive is dried in a heating tunnel, in the course of which it is chemically crosslinked, and at the end of the dryer it is wound up into jumbo rolls, gently corona-treated on the uncoated side after 1 week, and at that stage rewound to give log rolls with a running length of 25 m. These log rolls are stored in an oven at 100° C. for 1 hour. The log rolls are slit by parting by means of a slightly blunt, rotating blade (round blade) into rolls with a width of 15 mm.

This wrapping foil features balanced properties and has a slightly matt surface. The holding power is more than 2000 min (at which point measurement was terminated). The breaking elongation is 36% lower than in the case of samples with blade slitting. The unwind force is 25% higher than in the case of samples without conditioning.

### Example 4

Production takes place as in example 1, with the following changes:

the compound is composed of 100 phr of polymer A, 125 phr of Magnifin H 5 GV, 10 phr of Flammruβ 101, 2 phr of Irganox 1010, 1.0 phr of Irganox PS 802 and 0.4 phr of Irgafos 168.

After one week's storage, the film is flame-pretreated on one side and coated at 30 g/m² (dry application) with Airflex EAF 60. The web is dried initially with an IR lamp and then to completion in a tunnel at 100° C. Subsequently the tape is wound up to form jumbo rolls (large rolls). In a further operation the jumbo rolls are unwound and the uncoated side of the wrapping foil is subjected to weak corona treatment in a slitting machine for the purpose of increasing the unwind force, and is processed by blunt crush cutting to give rolls 33 m long in a width of 19 mm on a 1½-inch core (37 mm inside diameter). The breaking elongation is 48% lower than in the case of samples with blade cutting. The unwind force is 60% higher than in the case of samples without corona treatment. With respect to application, two fingers can be accommodated in the core, which facilitates winding in relation to example 1.

### Example 5

The compound is produced on a pin extruder (Buss) without carbon black, with underwater granulation. After drying, the compound is mixed with the carbon black masterbatch in a concrete mixer.

The carrier film is produced on a blown-film extrusion line, using the following formula: 100 phr of polymer B, 125 phr of brucite 15μ, 20 phr of a compound of 50% by weight Flammruβ 101 and 50% by weight polyethylene, 0.8phr of Irganox 1076, 0.8phr of Irganox PS 800, 0.2 phr of Ultranox 626 and 0.6 phr of Naugard XL-1.

The film bubble is slit and opened with a triangle to give a flat web, which is guided via a heat-setting station, corona-treated on one side and stored for a week for post-crystallization. For leveling (improvement of the planar lie) the film is guided over 5 preheating rolls on the coating line, coating otherwise taking place with pressure-sensitive adhesive in the same way as in example 1, and then the log rolls are conditioned at 65° C. for 5 hours and slit as in example 1.

Without heat-setting, the film exhibits marked contraction (5% in width, length not measured) during the drying operation. The planar lie of the freshly produced film is good, and it is coated immediately after extrusion; unfortunately, after three weeks' storage at 23° C., the rolls have already undergone marked telescoping. This problem can also not be eliminated by conditioning the log rolls (10 hours at 70° C.).

Thereafter the film is stored for a week prior to coating; telescoping of the rolls is now only partial, but in the course of coating the planar lie is so poor and the application of adhesive so irregular that preheating rolls were installed on the line.

The film features good heat resistance, i.e., without melting or embrittlement, in the case of additional storage at 170° C. for 30 minutes.

### Example 6

Production takes place as in example 1, with the following changes:

the film contains 80 phr of polymer C, 20 phr of Escorene UL 00119, 130 phr of Kisuma 5 A, 15phr of Flammruβ 101, 0.8 phr of Irganox 1010, 0.8 phr of Irganox PS 802 and 0.3 phr of Irgafos 168.

This carrier film is corona-treated on one side and stored for a week. The pretreated side is coated with 0.6 g/m² of an adhesion promoter layer comprising natural rubber, cyclo rubber and 4,4′-diisocyanatodiphenylmethane (solvent: toluene) and dried. The coating of adhesive mass is applied directly to the adhesion promoter layer using a comma bar with an application rate of 18 g/m² (based on solids). The adhesive mass is composed of a solution of a natural rubber adhesive mass in n-hexane with a solids content of 30 percent by weight. These solids are made up of 50 parts of natural rubber, 10 parts of zinc oxide, 3 parts of rosin, 6 parts of alkylphenolic resin, 17 parts of terpene-phenolic resin, 12 parts of poly-β-pinene resin, 1 part of Irganox 1076 antioxidant and 2 parts of mineral oil. This subsequent coat is dried in a drying tunnel at 100° C. Immediately downstream of this, the film is slit in a composite automatic slitter featuring a knife bar with sharp blades at a distance of 19 mm, to form rolls on standard adhesive-tape cores (3 inch).

Despite its high filler fraction, this wrapping foil is distinguished by very high flexibility, which is reflected in a low force value at 1% elongation. This wrapping foil has mechanical properties similar to those of plasticized PVC winding tapes, and is even superior in terms of flame retardancy and thermal stability. The holding power is 1500 min and the unwind force at 30 m/min (not 300 mm/min) is 5.0 N/cm. The fogging number is 62% (probably as a result of the mineral oil in the adhesive). Because of the large diameter of the roll, the roll can be pulled through only obliquely between winding board and cable harness, producing creases in the winding.

Properties of the Inventive Examples

| | Example | Example | Example | Example | Example | Example |
|---|---|---|---|---|---|---|
| | 1 | 2 | 3 | 4 | 5 | 6 |
| Film thickness [mm] | 0.08 | 0.09 | 0.095 | 0.085 | 0.06 | 0.11 |
| Bond strength steel [N/cm] | 2.8 | 3.1 | 2.3 | 1.9 | 2.8 | 3.0 |
| Bond strength to own reverse | 1.9 | 2.1 | 1.8 | 1.6 | 1.7 | 1.8 |
| [N/cm] | | | | | | |
| Unwind force [N/cm] | 2.1 | 2.4 | 2.1 | 1.8 | 2.5 | 2.7 |
| Tensile strength* [N/cm] | 9.8 | 7.0 | 11.1 | 6.8 | 4.1 | 9.0 |
| Breaking elongatlon* [%] | 640 | 880 | 860 | 830 | 600 | 1044 |
| Force at 1% elongation [N/cm] | 2.3 | 2.7 | 2.4 | 2.0 | 1.4 | 1.7 |
| Force at 100% elongation [N/cm] | 5.4 | 8.6 | 9.3 | 5.1 | 3.2 | 5.3 |
| Breaking elongation* after 20 d | 320 | 270 | 390 | 620 | 350 | 530 |
| @ 136° C. [%] | | | | | | |
| Breaking elongation* after | yes | yes | yes | yes | yes | yes |
| 3000 h @ 105° C. >100% | | | | | | |
| Thermal stability 168 h @ 140° C. | yes | yes | yes | yes | yes | yes |
| Heat resistance 30 min @ 170° C. | yes | yes | yes | yes | yes | yes |
| Compatibility with PE and PP | no | no | no | no | no | no |
| cables | embrittle- | embrittle- | embrittle- | embrittle- | embrittle- | embrittle- |
| 3000 h @ 105° C. | ment | ment | ment | ment | ment | ment |
| Compatibility with PE and PP | no | embrittle- | no | no | winding | no |
| cables | embrittle- | ment | embrittle- | embrittle- | film | embrittle- |
| 2000 h @ 125° C. | ment | | ment | ment | brittle | ment |
| Hand tearability | ++ | ++ | + | ++ | +++ | −− |
| LOl [%] | 23.6 | 20.0 | 22.8 | 20.1 | 20.0 | 24.1 |
| Flame spread rate | 35 | 160 | 87 | 160 | 183 | self- |
| FMVSS 302 [mm/min] | | | | | | extin- |
| | | | | | | guishing |
| Breakdown voltage [kV/100 μm] | 5 | 4 | 5 | 5 | 7 | 6 |
| Fogging number | 97 | 93 | 94 | 99 | 93 | 62 |
| Absence of halogen | yes | yes | yes | yes | yes | yes |
| Phosphorus content >0.5 phr | yes | yes | yes | yes | yes | yes |

*on specimens slit using blades

### Comparative Example 1

Coating is carried out using a conventional film for insulating tape, from Singapore Plastic Products Pte, under the name F2104S. According to the manufacturer the film contains about 100 phr (parts per hundred resin) of suspension PVC with a K value of 63 to 65, 43 phr of DOP (di-2-ethylhexyl phthalate), 5 phr of tribasic lead sulfate (TLB, stabilizer), 25 phr of ground chalk (Bukit Batu Murah Malaysia with fatty acid coating), 1 phr of furnace black and 0.3 phr of stearic acid (lubricant). The nominal thickness is 100 μm and the surface is smooth but matt.

Applied to one side is the primer Y01 from Four Pillars Enterprise, Taiwan (analytically acrylate-modified SBR rubber in toluene) and atop that 23 g/m² of the adhesive IV9 from Four Pillars Enterprise, Taiwan (analytically determinable main component: SBR and natural rubber, terpene resin and alkylphenolic resin in toluene). Immediately downstream of the dryer, the film is slit to rolls in an automatic composite slitter having a knife bar with sharp blades at a distance of 25 mm.

The elongation at break after 3000 h at 105° C. cannot be measured, since as a result of plasticizer evaporation the specimen has disintegrated into small pieces. After 3000 h at 85° C. the breaking elongation is 150%.

### Comparative Example 2

Example 4 of EP 1 097 976 A1 is reworked.

The following raw materials are compounded in a compounder: 80 phr of Cataloy KS-021 P, 20 phr of Evaflex P 1905, 100 phr of Magshizu N-3, 8 phr of Norvaexcel F-5 and 2 phr of Seast 3H, and the compound is granulated, but the mixing time is 2 minutes.

In a preliminary experiment it is found that with a mixing time of 4 minutes the melt index of the compound increases by 30% (which may be due to the absence of a phosphite stabilizer or to the greater mechanical degradation owing to the extremely low melt index of the polypropylene polymer). Although the filler was dried beforehand and a venting apparatus is located above the kneading compounder, a pungent phosphine odor is formed on the line during kneading.

The carrier film is subsequently produced by means of extrusion as described in example 7 (with all three extruders being fed with the same compound) via a slot die and chill roll in a thickness of 0.20 mm, the rotational speed of the extruder being reduced until the film reaches a speed of 2 m/min.

In a preliminary experiment it is not possible to achieve the speed of 30 m/min as in example 7, since the line shuts down owing to excess pressure (excessive viscosity).

In a further preliminary experiment the film is manufactured at 10 m/min; the mechanical data in machine and cross directions pointed to a strong lengthwise orientation, which is confirmed in the course of coating by a 20% contraction in machine direction. The experiment is therefore repeated with an even lower speed, which gave a technically flawless (including absence of specks) but economically untenable film.

Coating takes place in the same way as in example 3, but with adhesive applied at 30 g/m² (the composition of this adhesive is similar to that of the original adhesive of the patent example reworked). Immediately downstream of the dryer, the film is divided into strips 25 mm wide, using a knife bar with sharp blades, and in the same operation is wound into rolls.

The self-adhesive winding tape is notable for a lack of flexibility. As compared with example 5 or 6, the rigidity of comparative example 2 is higher by 4030% or 19 000%, respectively.

As is known, the rigidity can be calculated easily from the thickness and the force at 1% elongation (proportional to the elasticity modulus). Because of the red phosphorus it contains, and because of the relatively high thickness, the specimen exhibits very good fire performance (note: the LOI value was measured on the 0.2 mm thick sample with adhesive, whereas the LOI of 30% in the cited patent originates from a 3 mm thick test specimen without adhesive).

### Comparative Example 2a

The breakdown voltage of 2 kV/100 μm for comparative example 2 is too low for use as an insulating tape, in order to achieve an adequate absolute breakdown voltage at thicknesses which allow acceptable flexibility. The low breaking elongation points to inhomogeneities which, although beneficial to hand tearability, have an adverse effect on the breakdown voltage.

In a supplementary experiment, 2a, the compound is mixed more intensely.

By this means an improvement is achieved in the breakdown voltage to 4 kV/100 μm, but in tandem with a deterioration in the hand tearability and an increase in the breaking elongation to 570%.

By using the slitting process of the invention the hand tearability would probably be acceptable.

The examples of EP 1 097 976 A1 have a breaking elongation of the order of 300%, which generally points to poor mixing and hence low breaking elongation and low breakdown voltages.

### Comparative Example 2b

In view of the technical problems that occurred an attempt is made to carry out manufacturing under conditions as in example 1, with a calender process, it having been found beforehand, by chance, that a low melt index is no problem in the case of the polypropylene polymer for the calender process, but instead is in fact an almost mandatory prerequisite.

Since the formula of example 4 of EP 1 097 976 A1 is inadequate in terms of mechanical properties, the formula from experiment 1 is processed: 80 phr of Cataloy KS-353 P, 20 phr of Evaflex P 702, 100 phr of Magshizu N-4, 8 phr of Norbaexcel F5 and 2 phr of Seast 3H.

The mixture sticks to the calender rolls to such an extent that it is impossible to produce a film specimen. Therefore, first 0.2 phr of stearic acid is added, as a conventional lubricant, and in the absence of remedy 5 phr of Baerostab UBZ 639 (conventional calender additive package made up of stabilizer and lubricant, from Baerlocher) are added as well, but likewise fail to solve the processing problem.

The reason is regarded as lying in the large amount of EEA polymer, since EEA and EVA exhibit high specific adhesion to chromium and steel. As the skilled worker realizes, the problem could possibly be solved by a massive increase in the filler content; since, however, a compression molding 0.2 mm thick produced from the compound already appears too rigid, a film with a higher filler content would certainly have had no prospect of being sufficiently flexible.

### Comparative Example 3

Example A of WO 97/05206 A1 is reworked.

The production of the compound is not described. The components are therefore mixed on a twin-screw laboratory extruder with a length of 50 cm and an L/D ratio of 1:10: 9.59 phr of Evatane 2805, 8.3 phr of Attane SL 4100, 82.28 phr of Evatane 1005 VN4, 74.3 phr of Martinal 99200-08, 1.27 phr of Irganox 1010, 0.71 phr of AMEO T, 3.75 phr of black masterbatch (prepared respectively from 60% by weight of polyethylene with MFI=50 and 40% by weight of Furnace Seast 3 H), 0.6 phr of stearic acid and 0.60 phr of Luwax AL 3.

The compound is granulated, dried and blown on a laboratory line to form a film bubble, which is slit both sides. An attempt is made to coat the film with adhesive after corona pretreatment, as in example 1; however, the film exhibits excessive contraction in the cross and machine directions, and because of excessive unwind force it is hardly still possible to unwind the rolls after 4 weeks.

This is therefore followed by an experiment at coating with an apolar rubber adhesive as in example 6, but this attempt fails because of the sensitivity of the film to solvent. Since the publication indicated does not describe coating with adhesive, but does describe adhesive properties that are to be aimed at, the film is slit up with shears between a set of pairs of two rotating knives each, to give strips 25 mm wide, which are wound.

The self-adhesive winding tape features good flexibility and flame retardancy. The hand tearability, however, is inadequate. A particular disadvantage, though, is the low heat distortion resistance, which leads to the adhesive tape melting when the aging tests are carried out. Moreover, the winding tape results in a considerable shortening of the lifetime of the cable insulation, as a result of embrittlement. The high contraction tendency is caused by the inadequate melt index of the compound. Even with a higher melt index of the raw materials, problems are likely, despite the fact that the contraction will become much lower as a result, since no heat-setting is envisaged in the stated publication, despite the low softening point of the film. Since the product exhibits no significant unwind force it is almost impossible to apply to wire bundles. The fogging number is 73% (probably owing to the paraffin wax).

### Comparative Example 4

Example 1 of EP 0 953 599 A1 is reworked.

The preparation of the compound is mixed as described on a single-screw laboratory extruder: 85 phr of Lupolex 18 E FA, 6 phr of Escorene UL 00112, 9 phr of Tuftec M-1 943, 63 phr of Magnifin H 5, 1.5 phr of magnesium stearate, 11 phr of Novaexcel F 5, 4 phr of Carbon Black FEF, 0.2 phr of Irganox 1010 and 0.2 phr of Tinuvin 622 LD, a marked release of phosphine being apparent from its odor.

Film production takes place as in comparative example 3.

The film, however, has a large number of specks of filler and has small holes, and the bubble tears a number of times during the experiment. The breakdown voltage varies widely from 0 to 3 kV/100μ. For further homogenization, therefore, the granules are melted again in the extruder and granulated. The compound now obtained has only a small number of specks. Coating and slitting take place as in example 1.

Through the use of red phosphorus, the self-adhesive winding tape features very good flame retardancy. Since the product has no unwind force, it is virtually impossible to apply to wire bundles. The thermal stability is inadequate, owing to the low melting point.

### Comparative Example 5

Example 1 is repeated, with the Magnifin content lowered to 100 phr.

### Comparative Example 6

Example 1 of U.S. Pat. No. 5,498,476 A1 is reworked.

The following mixture is prepared in a Brabender plastograph (mixing time 5 min): 80 phr of Elvax 470, 20 phr of Epsyn 7506, 50 phr of EDAP, 0.15 phr of A 0750 and 0.15 phr of Irganox 1010.

The compound is compressed in a heated press between two sheets of siliconized polyester film to give test specimens 0.2 mm thick, which are cut into strips 25 mm wide and 25 cm long and wound onto a core to form a small roll. Coating with adhesive does not take place according to the specification.

This wrapping foil possesses neither acceptable flexibility nor resistance to melting. Since the product has no unwind force, it is virtually impossible to apply to wire bundles. It is difficult to tear into by hand. The breakdown voltage is relatively high, since the mixture is apparently very homogeneous, the Brabender mixer carries out mixing very intensely, and the aminosilane might also make a positive contribution, as suggested by the force/elongation curves of the cited patent.

### Comparative Example 7

Example 1 of WO 00/71634 A1 is reworked.

The following mixture is produced in a compounder: 80.8 phr of ESI DE 200, 19.2 phr of Adflex KS 359 P, 30.4 phr of calcium carbonate masterbatch SH3, 4.9 phr of Petrothen PM 92049, 8.8 phr of antimony oxide TMS and 17.6 phr of DE 83-R.

The compound is processed to flat film on a laboratory casting line, corona-pretreated, coated at 20 g/m² with JB 720, wound into log rolls with a 3-inch core, and slit by parting with a fixed blade (advanced by hand).

This winding tape features PVC-like mechanical behavior: that is, high flexibility and good hand tearability. A disadvantage is the use of brominated flame retardants. Moreover, the heat distortion resistance at temperatures above 95° C. is low, so that the film melts during the aging and compatibility tests.

Properties of the Comparative Examples

| | Comp. | Comp. | Comp. | Comp. | Comp. | Comp. | Comp. |
|---|---|---|---|---|---|---|---|
| | ex. 1 | ex. 2 | ex. 3 | ex. 4 | ex. 5 | ex. 6 | ex. 7 |
| Film thickness [mm] | 0.08 | 0.20 | 0.15 | 0.20 | 0.08 | 0.20 | 0.125 |
| Bond strength steel | 1.8 | 3.3 | 2.0 | 1.9 | 2.6 | 2.2 | 2.3 |
| [N/cm] | | | | | | | |
| Bond strength to own | 1.6 | 1.5 | 1.8 | 1.4 | 1.5 | 1.6 | 1.2 |
| reverse [N/cm] | | | | | | | |
| Unwind force [N/cm] | 2.0 | 1.8 | 1.9 | 1.7 | 1.9 | 2.1 | 1.5 |
| Tensile strength* [N/cm] | 15 | 10.9 | 22.3 | 44.0 | 14.2 | 16.1 | 22.5 |
| Breaking elongation* [%] | 150 | 370 | 92 | 720 | 870 | 720 | 550 |
| Force at 1% elongation | 1.0 | 11.4 | 4.3 | 5.9 | 1.4 | 3.5 | 0.46 |
| [N/cm] | | | | | | | |
| Force at 100% elongation | 14.0 | 9.2 | — | 19.8 | 6.8 | 9.1 | 6.3 |
| [N/cm] | | | | | | | |
| Breaking elongation* after | embrittled | embrittled | melted | melted | 420 | melted | melted |
| 20 d @ 136° C. [%] | | | | | | | |
| Breaking elongation* after | embrittled | embrittled | yes | yes | not | embrittled | embrittled |
| 3000 h @ 105° C. | | | | | embrittled | | |
| >100% | | | | | | | |
| Compatibility with PE and | no | PE yes | cable | tape | yes | no | tape |
| PP cables | | PP no | embrittled | fragile | | | fragile |
| 3000 h @ 105° C. | | | | | | | |
| Thermal stability 168 h @ | no | yes | no | no | yes | no | no |
| 140° C. | | | | | | | |
| Heat resistance 30 min @ | no | yes | no | no | yes | no | no |
| 170° C. | | | | | | | |
| Compatibility with PE and | no | no | tape | tape | yes | no | tape |
| PP cables | | | melted | melted | | | melted |
| 2000 h @ 125° C. | | | | | | | |
| Hand tearability | +++ | −− | − | −− | −−− | + | + |
| LOl [%] | 21.4 | 27.1 | 19.3 | 28.3 | 19.2 | 17.9 | 32.6 |
| Flame spread rate | 324 | self- | 463 | self- | 240 | 213 | self- |
| FMVSS 302 [mm/min] | | extin- | | extin- | | | extin- |
| | | guishing | | guishing | | | guishing |
| Breakdawn voltage | 4 | 2 | 3 | 3 | 6 | 4 | 4 |
| [kV/100 μm] | | | | | | | |
| Fogging number | 29 | 66 | 73 | 63 | 98 | 53 | 73 |
| Absence of halogen | no | yes | yes | yes | yes | yes | no |
| Presence of phosphorus | yes | no | yes | no | yes | no | yes |
| <0.5 phr | | | | | | | |

*on specimens slit using blades

1. A halogen-free, flame-resistant wrapping foil, characterized in that the wrapping foil is composed of polyolefin and contains more than 120 phr of metal hydroxide, preferably aluminum hydroxide and more preferably magnesium hydroxide.

2. The wrapping foil of claim 1, characterized in that the metal-hydroxide content is more than 150 phr.

3. The wrapping foil of claim 1 or 2, characterized in that the fraction of carbon black is at least 5 phr, preferably at least 10 phr, the carbon black preferably having a pH of 6 to 8.

4. The wrapping foil of at least one of the preceding claims, characterized in that the wrapping foil comprises at least one polypropylene
having a flexural modulus of less than 900 MPa, preferably of 500 or less, and more preferably of 80 MPa or less, and/or
a crystallite melting point of between 120° C. and 166° C., preferably below 148° C., more preferably below 145° C.

5. The wrapping foil of at least one of the preceding claims, characterized in that the thickness of the wrapping foil is 30 to 180 μm, particularly 50 to 150 μm, more particularly 55 to 100 μm,
the force in machine direction at 1% elongation has a value of 0.6 to 5 N/cm, particularly 1 to 3 N/cm,
the force at 100% elongation has a value of 2 to 20 N/cm, particularly 3 to 10 N/cm, and/or
the crystallite melting point of the polypropylene copolymer is less than 166° C.

6. The wrapping foil of at least one of the preceding claims, characterized in that the wrapping foil is free from red phosphorus and the chemically bonded phosphorus content preferably does not exceed 0.5 phr.

7. The wrapping foil of at least one of the preceding claims, characterized in that it comprises not only the preferred polypropylene polymer but also ethylene-propylene copolymers from the classes of EPM and EPDM polymers.

8. The wrapping foil of at least one of the preceding claims, characterized in that it has on one or both sides, especially one side, a layer of adhesive, which is preferably based on polyisoprene, ethylene-vinyl acetate copolymer and/or polyacrylate, and if desired has a primer layer between film and adhesive layer,
the amount of the adhesive layer being in each case 10 to 40 g/m², preferably 18 to 28 g/m²,
the bond strength to steel being 1.5 to 3 N/cm,
the unwind force being 1.2 to 6.0 N/cm at 300 mm/min unwind speed, preferably 1.6 to 4.0 N/cm, more preferably 1.8 to 2.5 N/cm, and/or
the holding power being more than 150 min.

9. The wrapping foil of at least one of the preceding claims, characterized in that it comprises a solvent-free pressure-sensitive adhesive which is produced by coextrusion, melt coating or dispersion coating, preferably a pressure-sensitive dispersion adhesive and in particular one based on polyacrylate, this adhesive being joined to the surface of the carrier foil by means of flame or corona pretreatment or of an adhesion promoter layer which is applied by coextrusion or coating.

10. The wrapping foil of at least one of the preceding claims, characterized in that the oxygen index (LOI) is above 20%, preferably above 23%, and more preferably above 27%.

11. Use of a wrapping foil of at least one of the preceding claims for bundling, protecting, labeling, insulating or sealing ventilation pipes or wires or cables and for sheathing cable harnesses in vehicles or field coils for picture tubes.
